(19) United States
(12) Patent Application Publication
(10) Pub. No.: US 2007/0221735 A1
(43) Pub. Date: Sep. 27, 2007

(54) Optical reading device

(75) Inventors: Hu-Sung Chang, Taipei City (TW); Meng-Hsun Chan, Taipei City (TW)

Correspondence Address: BACON & THOMAS, PLLC, 625 SLATERS LANE, FOURTH FLOOR, ALEXANDRIA, VA, 22314, US

(73) Assignee: ASUSTEK COMPUTER INC., Taipei City (TW)

(21) Appl. No.: 11/652,625

(22) Filed: Jan. 12, 2007

(30) Foreign Application Priority Data
Mar. 21, 2006 (TW) 095109612

(51) Int. Cl. G06K 7/10

(52) U.S. Cl. 235/473; 235/454

(57) ABSTRACT

An optical reading device is disclosed, in which the size and weight thereof are reduced, and the shock resistibility of the spindle motor thereof is improved. The optical reading device comprises a casing and an optical reader, wherein the optical reader thereof is received inside the casing. The optical reader includes a first portion, a second portion, and an optical fiber. The first portion is mounted inside the casing, while the second portion is mobile inside the casing. The optical fiber connects with the first portion and the second portion respectively, which enables the light to be emitted from the light source of the first portion and to be transmitted to the second portion and the data storage medium thereof. Hence, by the arrangement of the units illustrated, the weight of the optical reader device is reduced, and the shock resistibility of the optical reader thereof is improved as well.

### BACKGROUND OF THE INVENTION

1. Field of the Invention

The present invention relates to an optical reading device and, more particularly, to an optical reading device, of which the size and the weight of the optical reader thereof can be reduced.

2. Description of Related Art

The optical readers in the optical reading devices that has been widely utilized in the related industry are classified into three groups, according to the theories applied, which are (1) a holographic volume optical reader, (2) a planar light guide optical reader and (3) a MEMS optical platform reader. However, the basic structure of these three models is rather similar as shown in FIG. 1.

FIG. 1 illustrates a prior art optical reading device, which comprises a casing (not shown in the figure) and an optical reader 1 inside the casing for reading data stored in the storage medium 3. The optical reader 1 comprises a light source 11, a light sensing unit 12, an objective lens 13, a beam splitting unit 14 and a quarter-wave plate 15.

As the optical reader 1 of the conventional optical reading device is set to read the data from the storage medium 3, the optical reader is first moved to a predetermined position. The light source 11 then emits an incident light beam that passes through the beam splitting unit 14, the quarter-wave plate 15 and the objective lens 13 before it projects onto the surface of the storage medium 3. The incident light beam is reflected off the storage medium 3 and forms a reflected light beam. The reflected light beam then sequentially passes through the objective lens 13, the quarter-wave plate 15 and reaches the beam splitting unit 14. Next the reflected light beam takes another optical path to reach the light sensing unit 12, which eventually converts the light beam into an electric signal.

As being set to read the data off the different areas on the surface of the storage medium 3, all the components (e.g. the light source 11, the light sensing unit 12, the objective lens 13, the beam splitting unit 14 and the quarter-wave plate 15) of the optical reader of a conventional optical reading device need to be moved to a predetermined position simultaneously so that the light coming from the light source 11 can be accurately projected onto a predetermined area on the surface of the storage medium 3. The components that need to be moved (the entire optical reader 1 in this casing) during the reading process contain a certain amount of size and weight that prevents the conventional optical reading device from further downsizing, and a step motor with greater output and a higher-standard driving screw are required in order to drive and adjust the position of the optical reader. Also, after vigorous vibration (e.g. a drop test), the spindle motor, which is used to rotate the storage medium, would be easily detached due to a weak support structure, and the flexible printed circuitry (FPC) would be easily disconnected as well due to inertia, resulting in failure of the entire device.

Therefore, it is desirable to provide an optical reading device, of which the size and the weight of the optical reader can be reduced, the output of the driving motor can be lower and the shock resistibility of the spindle motor can be strengthened.

### SUMMARY OF THE INVENTION

The optical reading device of the present invention, which is used to read data that are stored in a storage medium, comprises a casing and an optical reader. The optical reader, which is received in the casing, comprises a first portion that is mounted in the casing, an optical fiber and a second portion that shuttles in the casing. The first portion comprises at least one light source, and the optical fiber connects the first portion and the second portion. Also, the light beam emitted by the light source of the first portion is transmitted through the optical fiber to the second portion and the storage medium.

Since the optical reader of the optical reading device comprises a first portion that is mounted to the casing along with a second portion that shuttles in the casing, whilst an optical fiber is arranged to transmit light signals between the two portions, only the second portion, instead of the entire of the optical reader, will be moved for reading data from a storage medium. That is, the portion, which is required to move during operation (the second portion), in the optical reading device of the present invention is smaller in terms of the size than that (the entire optical reader) of the conventional optical reading device, making the span between the driving screw and the rail of optical reading device of the present invention much shorter than that of the conventional one. The opening required to form for the above span in the mounting structure for the spindle motor in the present invention can be further reduced accordingly, making the spindle motor more stably fixed with much better shock resistibility.

In addition, since the portion (the second portion) of the optical reading device that needs to move during operation weighs less than that (the entire optical reader) of the conventional optical reading device, the present invention merely requires a lower output step motor and a lower-standard driving screw in order to drive the second portion glidingly moving back and forth on the rail, such that the weight of the device can be further reduced, while the structure can be strengthen at the same time.

Also, since each the first portion and the second portion of the optical reader is arranged at different positions within the casing where only an optical fiber connects the two, the thickness of the optical reading device of the present invention can be further trimmed down, allowing a better shock resistibility.

The optical reading device of the present invention can further comprise any mechanical configuration, preferably a frame and a rail. The frame and rail are received in the casing, such that the first portion of the optical reader is mounted to the frame, and the second portion of the optical reader glidingly moves on the rail. The second portion of the optical reader can be powered by any type of driving device in order to glidingly move on the rail, preferably by a step motor. The second portion of the optical reader can further comprise any type of optical unit, preferably an optical lens. The first portion of the optical reader can further comprise any type of light sensing device, preferably a photodiode sensor. The first portion of the optical reader can further any type of light source, preferably a semiconductor light source and most preferred with a light emitting diode (LED).

### BRIEF DESCRIPTION OF THE DRAWINGS

FIG. 1 is the representational diagram illustrating a prior art optical reading device.

FIG. 2 is the representational diagram illustrating an embodiment of an optical reading device according to the preferred embodiment of the present invention.

FIG. 3 is the representational diagram illustrating an embodiment of fastening units for the optical fiber of an optical reading device according to the preferred embodiment of the present invention.

FIG. 4 is side view of an embodiment of an optical reading device according to the preferred embodiment of the present invention.

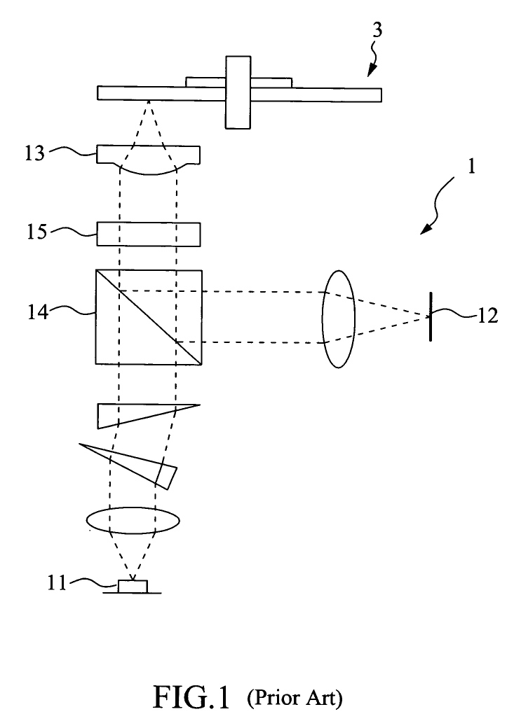

### DETAILED DESCRIPTION OF THE PREFERRED EMBODIMENT

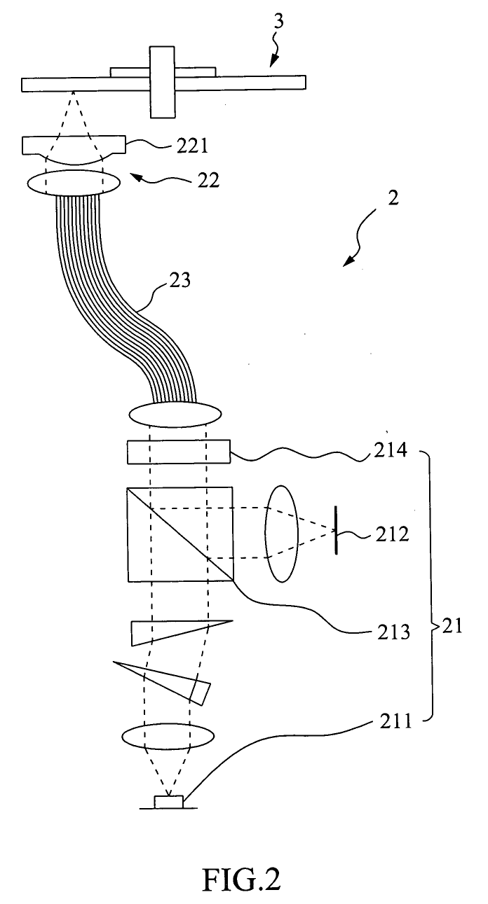

FIG. 2 illustrates an embodiment of an optical reading device according to the present invention, in which the optical reading device includes a casing (not shown in the figure) and an optical reader 2, which is received in the casing, for reading data stored in a storage medium 3. As shown in FIG. 2, the optical reader 2 further includes a first portion 21, a second portion 22 and an optical fiber 23. In this embodiment, the optical fiber may be a multimode fiber or a single mode fiber. The two ends of the optical fiber 23 are connected to the first portion 21 and the second portion 22 respectively, such that the light signals are transmitted between-the first portion 21 and the second portion 22.

The first portion 21 is mounted on a frame (not shown in the figure). The first portion 21 includes a light source 211, a light sensing unit 212, a beam splitting unit 213 and a quarter-wave plate 214 to provide the light required to read data from the storage medium 3 and to receive any reflected light beam that carries data from the surface of the storage medium 3. Besides, the light source 211 is preferably a semiconductor light source, and most preferably a light emitting diode (LED).

The second portion 22 includes an optical lens 221, which locates opposite to the surface of the storage medium 3, for projecting the light beam from the first portion 21 onto the surface of the storage medium 3 and receiving any reflected light beam from the surface of the storage medium 3.

When reading the data stored in the storage medium 3, the second portion 22 of the optical reader 2 of the optical reading device is driven by a step motor (not shown in the figure) to glidingly move on the rail (not shown in the figure) back and forth for reading data that are stored on different areas on the surface of the storage medium 3.

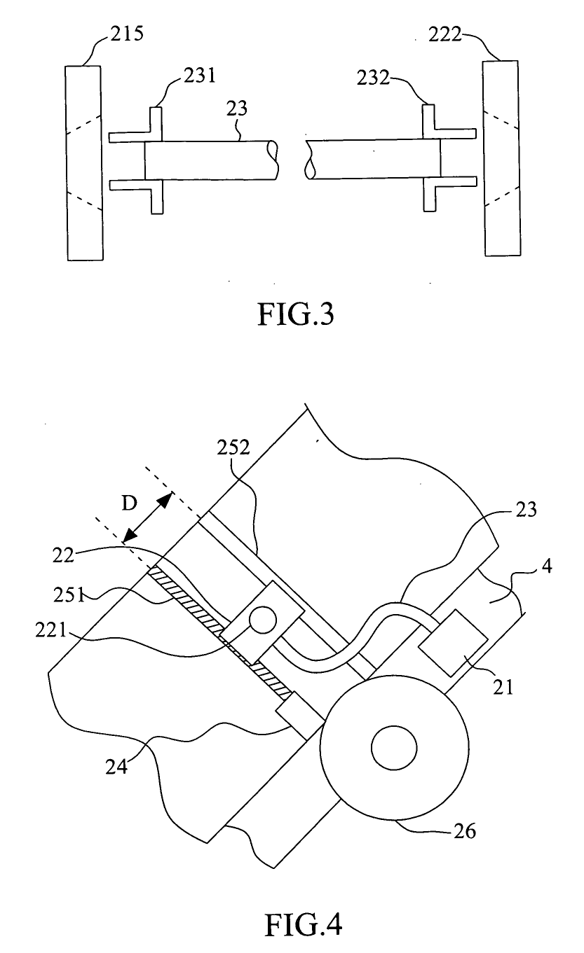

The arrangement for how the optical fiber 23 is coupled respectively to the first portion 21 and the second portion 22 is shown in FIG. 3. The two ends of the optical fiber 23 are attached to a first fastening unit 231 and a second fastening unit 232 respectively. Then to try to connect the optical fiber 23 with the first portion 21 and the second portion 22, the first fastening unit 231 and the second fastening unit 232 are embedded respectively in a first anchoring member 215 (on the first portion 21) and a second anchoring member 222 (on the second portion 22). With such simple fastening mechanism, the optical fiber 23 of the optical reading device can be easily coupled to the first portion 21 and the second portion 22 respectively, and a predetermined relative position of the first portion 21 to the second portion 22 can be kept in order to maintain the transmission efficiency of the light signals between the two portions.

The reading process of the optical reading device is illustrated with reference to both FIG. 2 and FIG. 4 as follows:

As the optical reading device reads the data that are stored in the storage medium 3, the step motor 24 first drives the second portion 22 to a predetermined position with the driving screw 251. Next the light source 211 of the optical reader 2 of the first portion 21 projects an incident light beam that in sequence passes through several optical lenses and beam splitting unit 213 to reach the quarter-wave plate 214. The light beam then in sequence passes through the quarter-wave plate 214 and the optical fiber 23 and reaches the optical lens 221 of the second portion 22 of the optical reader 2. The light beam then passes through the optical lens 221 and projects onto a specified position (where the data are stored) on the surface of the storage medium 3. The incident light beam soon is reflected off the surface of the storage medium 3 and forms a reflected light beam that contains data. The reflected light beam then in sequence passes through the optical lens 221, the optical fiber 23 and the quarter-wave plate 214 and reaches the beam splitting unit 213. At this moment, since the phase of an incident light beam and a reflected light beam varies, the reflected light beam takes a different optical path than what the incident light beam has taken and passes through the beam splitting unit 213 and reaches the light sensing unit 212. Finally the light sensing unit 212 converts the reflected light beam into an electric signal.

FIG. 4 is a side view of an embodiment of the optical reading device according to the present invention, in which the first portion 21 is mounted on the frame 4, and the second portion 22 glidingly moves back and forth on the driving screw 251 and the rail 252, driven by the driving screw 251 that is connected to a step motor 24, to read data stored on different areas on the surface of the storage medium 3.

The first portion 21 and the second portion 22 of the optical reader 2 are connected with the optical fiber 23, such that the incident light beams and reflected light beams are able to be transmitted in between the first portion 21 and the second portion 22.

Since the second portion 22 of the optical reader 2 of the preferred embodiment of the present invention has a smaller size and width than the entire optical reader of the conventional optical reading device, the span D between the driving screw 251 and the rail 252 can be reduced from 4cm in the conventional optical reading device down to just 1 cm in the present invention. Therefore, the opening (not shown in the figure) for the span in the mounting structure for the spindle motor 26 can be further reduced accordingly from 2 cm in the conventional device down to 0.5 cm in the present invention, such that the optical reading device can endure greater impacts and maintain its operation after series of drop tests.

Also, since the second portion of the optical reader weighs less than the entire optical reader in the conventional optical reading device, the amount of inertia generated from the motion of the second portion is accordingly lower than that from the motion of the entire optical reader of the convention one. The optical reading device of the preferred embodiment of the present invention is required only to equip with a lower output step motor and a lower-standard driving screw to drive the second portion glidingly moving back and forth on the driving screw and the rail for reading data that are stored on different areas on the surface of the storage medium. As a result, the weight of the optical reading device of the present invention can be further reduced, the structure of the optical reading device can be strengthened, and the cost of production thereof can be further cut at the same time.

Since each the first portion and the second portion of the preferred embodiment of the present invention are connected with an optical fiber, the present invention weighs far less than the conventional device that uses a flexible printed circuitry (FPC) as its means of connection. Therefore, after vigorous vibration from any outside forces (e.g. a drop test), the optical fiber can still remain securely coupled to both the first and the second portion, for which the light signals (incident light beams and reflected light beam) are able to be stably transmitted across. In other words, even having experienced vigorous vibrations (e.g. a drop test) from any outside forces, the optical reading device of the present invention can continue to operate without any failure to read data from the storage media.

Although the present invention has been explained in relation to its preferred embodiment, it is to be understood that many other possible modifications and variations can be made without departing from the scope of the invention as hereinafter claimed.

What is claimed is:

1. An optical reading device, configured to read data stored in a storage medium, comprising:
a casing; and
an optical reader received in the casing further comprising:
a first portion mounted in the casing comprising a light source, which emits a light beam;
an optical fiber; and
a second portion suitable for being mobile in the casing, wherein the optical fiber connects with the first portion and second portion respectively, and the light beam is transmitted to the second portion and the storage medium through the optical fiber.

2. The optical reading device as claimed in claim 1 further comprises a frame and a rail received in the casing, the first portion is mounted on the frame, and the second portion is configured to glidingly move on the rail.

3. The optical reading device as claimed in claim 1, wherein the second portion is driven by a step motor.

4. The optical reading device as claimed in claim 1, wherein the second portion further comprises an optical lens which is located opposite to the storage medium, a reflected light beam reflected by the storage medium passing through the optical lens.

5. The optical reading device as claimed in claim 4, wherein the reflected light beam is transmitted through the second portion and the optical fiber to the first portion.

6. The optical reading device as claimed in claim 4, wherein the first portion further comprises a light sensing device configured to receive the reflected light beam.

7. The optical reading device as claimed in claim 1, wherein the light source is a semiconductor light source.

8. The optical reading device as claimed in claim 1, wherein said first portion further comprises a first anchoring member, the second portion further comprises a second anchoring member, two ends of the optical fiber are mounted respectively to the first anchoring member and the second anchoring member.
